(19) United States
(12) Patent Application Publication
(10) Pub. No.: US 2002/0189297 A1
(43) Pub. Date: Dec. 19, 2002

(54) Method for the manufacture, ready for use, of an optical conductor

(76) Inventor: Claudio Meisser, Cham (CH)

Correspondence Address: Cohen Pontani Lieberman & Pavane, 551 Fifth Avenue, Suite 1210, New York, NY, 10176, US

(21) Appl. No.: 09/489,706

(22) Filed: Jan. 24, 2000

(30) Foreign Application Priority Data
Jan. 22, 1999 (EP) 99810048.1

(51) Int. Cl. C03B 37/018

(52) U.S. Cl. 65/392

(57) ABSTRACT

An optical conductor includes a transparent fiber of synthetic material, a reflective layer and a sheathing of synthetic material. The optical conductor is rotationally symmetrical relative to a fiber axis. The property and the position of the end race of the fiber are of decisive significance for the optical quality of a plug connection of two optical conductors. The ends of the optical conductors must be arranged at a minimum spacing one from the other and the fiber axes must be oriented exactly one onto the other. Usually, the end of the optical conductor is mounted in a ferrule, in which case it is important that, in a plug connection, the one end face is positioned exactly relative to the other end face. The projecting fiber end is severed by a laser beam, wherein an end face arises, which displays the required mechanical and optical qualities.

### BACKGROUND OF THE INVENTION

1. Field of the Invention

The invention relates to a method for the manufacture, ready for use, of an optical conductor which consists of fiber and sheath and which after being cut to length and stripped of sheathing is equipped with at least one connecting element.

2. Discussion of the Prior Art

Light is suitable for the transmission of information, wherein for example a digital modulation of the light is used in correspondence with the information to be transmitted. In that case, electrical signals are converted into optical signals and the information is transmitted by means of electronic components to optical components and conversely. Current flowing through a luminescent diode generates light in a transmitter, wherein the generated light energy changes according to diode current. The light is fed to a receiver which converts the light into a current at a specific voltage by means of a photo-diode, wherein the changing light correspondingly changes the diode current. The transmitter and the receiver are connected by means of an optical conductor which ensures that the light produced by the transmitter arrives with the least possible losses at the receiver. It is not always possible to connect the transmitter seamlessly with the receiver. In certain applications, the optical conductor must be able to be interrupted. For this purpose, plugs are necessary in comparable manner to an electrical connection, by means of which plugs the optical conductor connection is interruptible. In order to ensure a good connection, specific demands with respect to light losses are made on the coupling of the optical conductor to the transmitter or receiver or to the plug. The processing of the end faces, the surface roughness of the end faces, the shift of conductor axes, the spacing of the end faces and reflections at the end faces of the optical conductor have a direct influence on the light losses between transmitter and receiver.

Optical conductors are used, apart from for the transmission of information, also for applications in which light must be conducted, such as, for example, for illumination purposes or in optical or medical instruments and in traffic means or in buildings and so forth.

FIG. 1 shows an optical conductor 1 consisting of a transparent fiber 2, for example of synthetic material, a reflective layer 3, called cladding in the language of the art, and a sheathing 4, for example of synthetic material. The optical conductor is rotationally symmetrical to a fiber axis 5. Other fiber materials, for example on the base of glass, are also possible. For the optical quality of a plug connection of two optical conductors 1, the nature and the position of the end surface 6 or the fiber 2 is of decisive significance, as mentioned above. The ends of the optical conductor 1 must be arranged at a minimum spacing from each other aid the fiber axes 5 must be oriented exactly one relative to the other. In many embodiments, the end of the optical conductor 1 is mounted in a tubular plug part, also called a ferrule, which for the purpose of optical connection of two optical conductors 1 is plugged into a centring sleeve or into a housing. It is in that case important that one end face 6 is positioned exactly opposite the other end face 6. The same applies for the transition from the transmitter to the optical conductor 1 or from the optical conductor 1 to the receiver.

A method for the manufacture of a ferrule connection, in which one optical conductor fiber of synthetic material is plugged into a bore of a ferrule and retained firmly therein, is known from German Patent DE 195 29 527. The ferrule is heated up to the swelling temperature of the optical conductor fiber. During the heating to the swelling temperature, the fiber diameter enlarges in an irreversible manner, while the optical conductor fiber lays itself snugly against the inward wall surface of the bore and forms a tension-resistant seating with the ferrule. The bore of the ferrule is enlarged at one end and servos for the end face treatment of the optical conductor fiber, for which the end part of the fiber is melted by a heating plate and urged into the enlargement of the bore.

A disadvantage of the known equipment lies in the treatment of the end face of the optical conductor fiber by means of the heating plate. The heat treatment of the end face can last for about 5 seconds, which causes high manufacturing costs in particular during the mass production of optical conductors and moreover slows down the entire work sequence. FIG. 1a shows a planar end face 6 of the optical conductor fiber 2, which arises on the application of the heat treatment by means of a heating plate.

### SUMMARY OF THE INVENTION

It is an object of the present invention to create a remedy for the problem. The invention solves the problem of avoiding the disadvantages of the known equipment and of indicating a method by means of which the automatic manufacture, ready for use, of optical conductors with optically faultless properties is of interest economically.

Pursuant to this object, and others which will become apparent hereafter, one aspect of the present invention resides in a method for manufacturing a ready to use optical conductor consisting of a fiber and a sheathing surrounding the fiber, the method comprising the steps of cutting the conductor to a length and thereby forming an end face, stripping the sheathing from the cut length of conductor, and equipping the cut length with at least one connecting element. At least one of the fiber being cut to length using a laser beam and the end face being treated by a laser beam.

The advantages achieved by the method according to the invention are to be seen substantially in that the manufacture ready for use, in particular the treatment of the end face of the optical conductor, can be made within less than one second. Because the treatment of the end face taking most of the time of the manufacturing operation ready for use can be shortened substantially by the method according to the invention, automatic treatment equipments operating parallel with the end face treatment can be utilized better, since the working step needing most time determines the cycle rate for the entire treatment center. It is furthermore advantageous that, in spite of mass production, an unobjectionable mechanical and optical quality of the end face aid thus an optical connection with minimum attenuation losses is achievable. The treatment of the end face takes place contactlessly, whereby contaminations leading to absorption and scattering of the light or scratches on the end face are avoided. Losses due to oblique beam exit are avoided to a large extent by the slightly convex end face standing perpendicularly to the fiber axis. Scatter losses arising due to a rough surface of the end face do not occur, since the roughness of the end face is smaller than the wavelength. In order to prevent the fiber from being able to protrude from the ferrule and being damaged, the fiber can be cut along the end face ferule surface by the method according to the invention. Beyond that, it is prevented by the precise cut along the ferrule that the fiber can retract too far into the ferrule, the consequence of which would be excessive spacings in the plug and thus transmission losses. By the method according to the invention, no shrinkages take place at the fiber end after the treatment of the fiber and the fiber does not draw back into the ferrule. It is furthermore advantageous that the build-up of the ferrule and the equipping operation are simplified.

The various features of novelty which characterize the invention are pointed out with particularity in the claims annexed to and forming a part of the disclosure. For a better understanding of the invention, its operating advantages, and specific objects attained by its uses reference should be had to the drawing and descriptive matter in which there are illustrated and described preferred embodiments of the invention.

### BRIEF DESCRIPTION OF THE DRAWINGS

FIG. 1 shows an optical conductor with sheathing and a fiber for the conduction of light;

FIG. 1a shows all optical conductor fiber with a planar end face;

FIG. 1b shows an optical conductor fiber with a spherical end face;

FIGS. 2 to 7 show a method according to the invention for the manufacture, ready for use, of the optical conductor with a one-part ferrule;

FIG. 2 shows the cutting to length of the optical conductor;

FIG. 3 shows the stripping of the sheathing of die optical conductor;

FIG. 4 shows the positioning of a one-part ferrule;

FIG. 5 shows the introduction and connection of the optical conductor respectively into and with the ferrule;

FIG. 6 shows the treatment of the end face of the optical conductor fiber;

FIG. 7 shows the finished optical conductor made ready for use;

FIGS. 8 to 14 show a method according to the invention for the manufacture, ready for use, of the optical conductor with a multipart ferrule;

FIG. 8 shows the cutting to length of the optical conductor;

FIG. 9 shows the stripping of the sheathing of the optical conductor;

FIG. 10 shows the treatment of the end face of the optical conductor fiber;

FIG. 11 shows the introduction and connection of the optical conductor respectively into and with the ferrule;

FIG. 12 shows details of the multipart ferrule;

FIG. 13 shows the finished optical conductor made ready for use;

FIG. 14 shows a housing for the reception of the finished optical conductor made ready for use;

FIG. 15 shows au optical conductor end made ready for use and a housing;

FIG. 16 shows an optical conductor end with housing;

FIG. 17 shows both optical conductor ends with housings; and

FIG. 18 shows a schematic illustration or an introduction of light into an optical conductor.

### DETAILED DESCRIPTION OF THE PREFERRED EMBODIMENTS

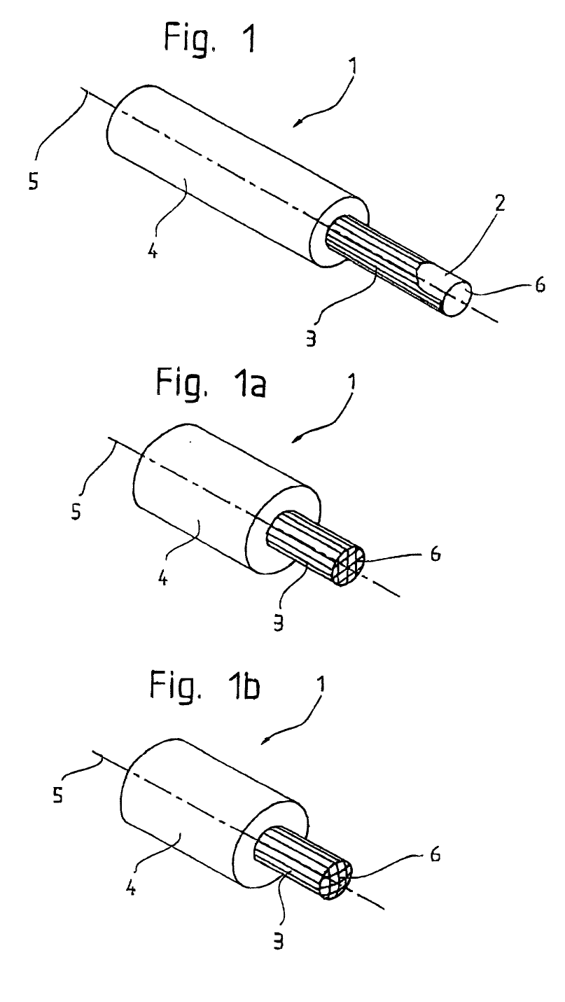

In FIGS. 1 to 18, an optical conductor I is denoted by 1 and consists of a transparent fiber 2, for example of synthetic material, a reflective layer 3, which is called cladding in the language of the art, and a sheathing 4, for example of synthetic material. The optical conductor 1 is rotationally symmetrical to a fiber axis 5. As mentioned above, the properties and the position of the end face 6 of the fiber 2 are of decisive significance for the optical quality or a plug connection of two optical conductors I. Further details of the optical conductor 1 are mentioned above. FIG. 1b shows a spherical end face 6 of the optical conductor fiber 2, which arises on the application of the method according to the invention.

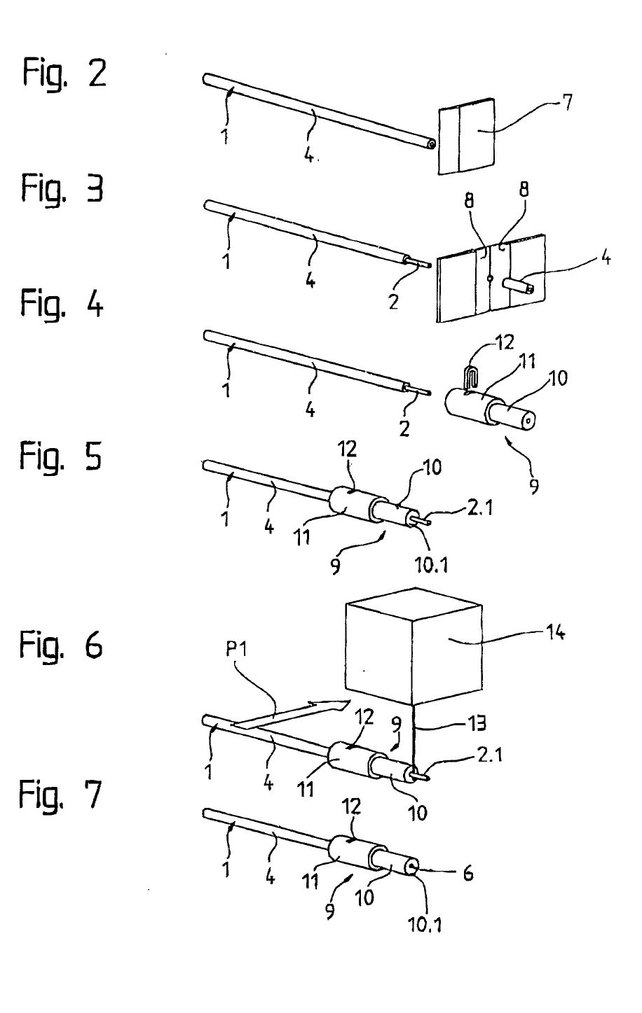

FIGS. 2 to 7 show the method according to the invention for the manufacture, ready for use, of an optical conductor 1. The method steps are executed by automatic machines operating, for example, in parallel. In FIG. 2, the optical conductor 1 is cut to the desired length by means of a severing blade 7. After the cutting to length, the stripping of the sheathing takes place as shown in FIG. 3, for which shaped blades 8 cut into the sheathing 4 and draw the sheathing off over the optical conductor end by a movement in the axial direction. The sheathing 4 is cut into precisely by the shaped blades 8 without damaging the reflective layer 3. A damaged reflective layer 3 would impair the optical quality of the connection. After the stripping of the sheathing 4, a ferrule 9 serving as connecting element is positioned with respect to the fiber axis 5, as shown in FIG. 4. The ferrule 9 consists of a fiber part 10 for the reception of the fiber 2 with the reflective layer 3 and of a sheathing part 11 for the reception of the sheathing 4. An arresting in the form of, for example, a pluggable clamp 12 connects the sheathing 4 mechanically with the sheathing part 11 for the purpose of tension relief of the fiber 2. FIG. 5 shows the optical conductor 1 introduced into the ferrule 9 and connected with the ferrule 9, wherein the fiber end 2.1 projects relative to an end face 10.1 of the fiber part 10. In FIG. 6, the projecting fiber end 2.1 is severed by means of a laser beam 13, for example of a CO₂ laser device 14 or the fiber 2 with the reflective layer 3 is cut to length precisely to the planar end face of the ferrule in that, for example, the optical conductor 1 is moved in arrow direction P1 through the laser beam 13. The arising end face 6 of the fiber 2 exhibits the required mechanical and optical qualities. The end face 6, produced mechanically and contactlessly by the laser beam 13 in, for example, about one second is clean and slightly convex or slightly spherical, as shown in FIG. 1b and in FIG. 18, which has a positive effect in terms of light losses. FIG. 7 shows the finished end of the optical conductor 1 made ready for use.

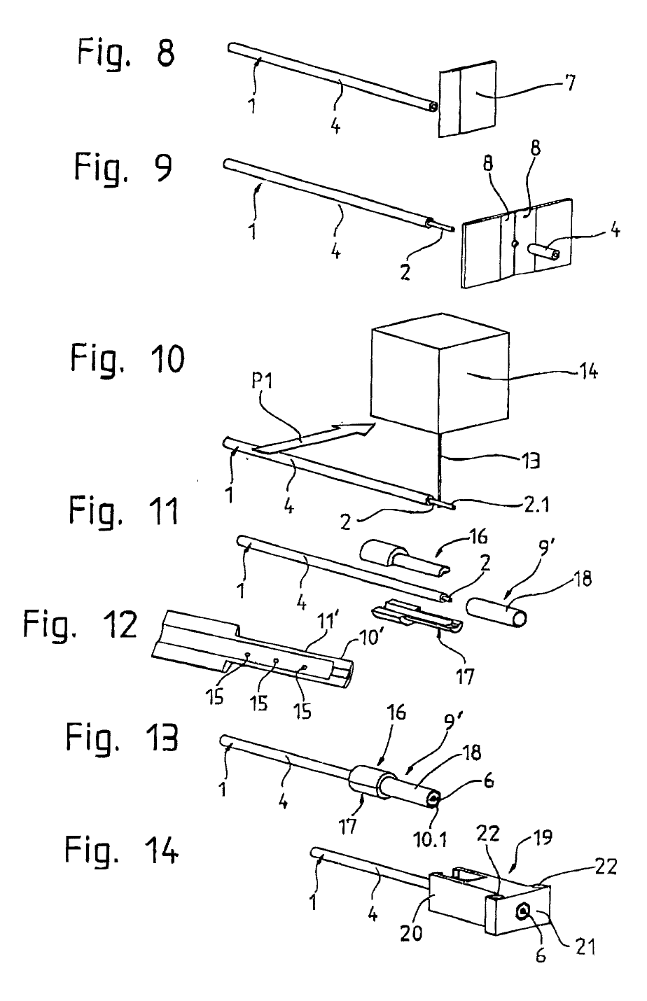

FIGS. 8 to 14 show the method according to the invention for the manufacture, ready for use, of an optical conductor 1 with a multipart ferrule 9′. In FIG. 8, the optical conductor 1 is cut to the desired length by means of the severing blade 7. FIG. 9 shows the stripping of the sheathing, for which the shaped blades 8 cut into the sheathing and draw the sheathing off over the optical conductor end by a movement in the axial direction. The sheathing 4 is cut into precisely by the shaped blades 8 without damaging the reflective layer 3. A damaged reflective layer 3 would impair the optical quality of the connection. In FIG. 10, the fiber end 2.1 is severed by means of the laser beam 13, for example of the CO₂ laser device 14, or the fiber 2 is cut to length precisely with the reflective layer 3, in that, for examples the optical conductor 1 is moved in arrow direction P1 through the laser beam 13. The arising end face 6 of the fiber 2 exhibits the required mechanical and optical qualities. The end face 6 produced without mechanical contact by the laser beam 13 in, for example, about one second is clean and slightly convex or spherical, as shown in FIGS. 1b and 18, which has a positive effect in matters of light introduction or light losses. After the cutting to length of the optical conductor fiber 2, a multipart ferrule 9′ is positioned with respect to the fiber axis 5, as shown in FIG. 11. The ferrule 9′ consists of the fiber part 10′ for the reception of the fiber 2 with the reflective layer 3 and of the sheathing part 11′ for the reception of the sheathing 4, wherein an upper half shell 16, a lower half shell 17 and a sleeve 18, which can be slid on, are provided. Each of the half shells 16, 17 comprises an arresting in the shape of prongs 15 (FIG. 12) that penetrate into the sheathing 4 for the purpose of tension relief of the fiber 2. The end of the optical conductor 1 is laid into the one half shell 16 or 17, and the other half shell 17 or 16 is laid on and the sleeve 18 is pushed over both the half shells. The end face 6 of the fiber 2 is, as shown by FIG. 13, positioned exactly flush with the planar end face 10.1, which is formed by the half shell 16 and 17 and the sleeve 18, of the ferrule 9′. The end face 6 of the fiber 2 may in no case project from the end face 10.1 of the ferrule 9′. FIG. 14 shows a housing 19, which consists of a ferrule part 20 and a fastening part 21, for the reception and retention of the ferrule 9′. Bores 22 for screws for fastening to a support are arranged at the fastening part 21. The ferrule 9 is laid into the housing 19, wherein the end face 6 of the fiber 2 is flush with the end face of the fastening part 21. The ferrule 9′ can be cast in place in the housing 19.

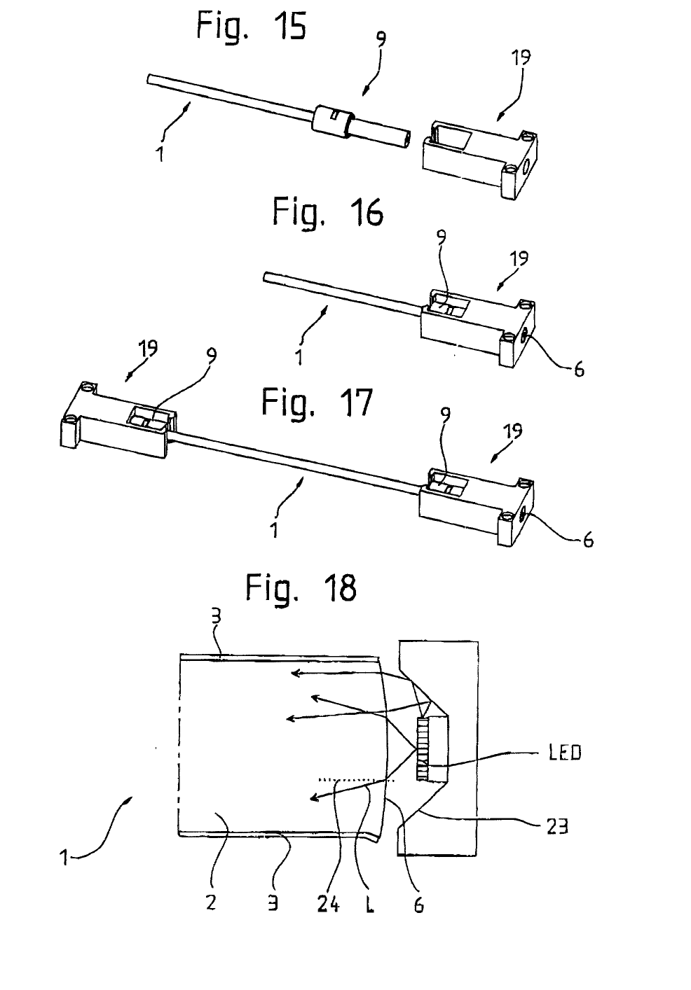

FIGS. 15 to 17 show the equipping operation of the housing 19 with a one-part ferrule 9″ and an optical conductor 1 equipped at both ends.

FIG. 18 shows the light introduction into an optical conductor 1 with the slightly spherical end fact 6. The light L of a transmitter LED passes directly into the fiber 2 or is deflected at a reflector 23 and then passes into the fiber 2, wherein a refraction to the perpendicular 24 takes place on light entry at the spherical end face 6 of the fiber 2.

The invention is not limited by the embodiments described above which are presented as examples only but can be modified in various ways within the scope of protection defined by the appended patient claims.

I claim:

1. A method for manufacturing a ready to use optical conductor which consists of a fiber and a sheathing, comprising the steps of: cutting the conductor to length so as to form an end face; stripping the sheathing from the cut length; and equipping the cut length with at least one connecting element, at least one of the fiber being cut to length by a laser beam and the end face being treated by a laser beam.

2. A method according to claim 1, including treating the end face of the fiber so that the end face is slightly spherical after the laser beam treatment.

3. A method according to claim 2, including treating the end face with a laser beam of a CO₂ laser device.

4. A method according to claim 1, wherein the equipping step includes equipping the optical conductor with a connecting element constructed as a ferrule before the laser beam treatment.

5. A method according to claim 1, wherein the equipping step includes equipping the optical conductor with a connecting element constructed as ferrule after the laser beam treatment.

6. A method according to claim, 4, wherein the equipping step includes equipping the optical conductor with a one-piece ferrule with a planar end face.

7. A method according to claim 5, wherein the equipping step includes equipping the optical conductor with a multipart ferrule including two half shells.

8. A method according to claim 7, including laying the end of the optical conductor into one of the half shells after the laser beam treatment, laying a further one of the half shells on the conductor end, and pushing a sleeve over both the half shells, the half shells and the sleeve forming a planar end face of the ferrule.
